(19) United States
(12) Patent Application Publication
(10) Pub. No.: US 2014/0257835 A1
(43) Pub. Date: Sep. 11, 2014

(54) Framework for Providing Workflow Guidance

(71) Applicant: Siemens Technology and Services Pvt. Ltd., Mumbai (IN)

(72) Inventor: Suman Kashyap, Bangalore (IN)

(73) Assignee: Siemens Technology and Services Pvt. Ltd., Mumbai (IN)

(21) Appl. No.: 14/195,900

(22) Filed: Mar. 4, 2014

Related U.S. Application Data
(60) Provisional application No. 61/773,260, filed on Mar. 6, 2013.

(51) Int. Cl. G06Q 10/06; G06Q 50/22

(52) U.S. Cl. CPC G06Q 10/0633; G06Q 50/22
USPC 705/2

(57) ABSTRACT

Disclosed herein is a framework for providing workflow guidance. In accordance with one aspect, a workflow graph is retrieved from a pre-built knowledge base. An end node of the workflow graph may represent a user's desired workflow point-state associated with a workflow system. The workflow graph may be used to determine the most efficient path from a current workflow point-state to the desired workflow point-state. A suggestion of the next task to be performed by the user may then be provided in accordance with the most efficient path.

### CROSS-REFERENCE TO RELATED APPLICATION

This application claims the benefit of U.S. provisional application No. 61/773,260 (Attorney Docket No. 2012P27412US) filed Mar. 6, 2013, the entire contents of which are incorporated herein by reference.

### TECHNICAL FIELD

The present disclosure generally relates to systems and methods for guiding a user through workflows.

### BACKGROUND

The most common way for a physician to delegate authority is to write an order on a patient's chart. The physician may personally write the order, or a nurse may enter it in the chart at the physician's direction. There are several types of orders, such as laboratory orders, medication orders, therapeutic procedure orders, diagnostic test orders, etc. Different orders may have different characteristics. For example, with medication orders, the user needs to define the medication name, select the dosage, the route of administration, the frequency of administration (e.g., how many times a day), the schema of administration (e.g., every day, once a day, etc.), and any other medication specifics. If the medication is to be administered intravenously, the clinician may have to enter the rate of intravenous (IV) pump flow and other additional information. In other words, the instructions in the medication order can become very complex.

A computerized physician order entry (CPOE) system may be used to facilitate such order entry. In general, a CPOE system enables a physician to enter an order electronically instead of using paper charts. The physician may select, via the CPOE system, desirable items from a hospital's or health system's orderable services to generate the order.

The use of a CPOE system can help to reduce errors related to poor handwriting or transcription of orders. It can also reap financial rewards for physician practices or hospital systems by meeting government mandates. However, implementing a computerized physician order entry (CPOE) system poses multiple non-trivial issues. One of the main pitfalls of CPOE implementation is the lack of training. Ensuring that training happens without disrupting the hospital organization's workflow is a real hurdle. In addition, the complexity of CPOE workflows raises many concerns regarding time management and data security. As such, CPOE implementation is often met with opposition from clinicians, particularly those who have been practicing for years and are accustomed to manually documenting patient information. Without the support and cooperation of administrative and physician staff, CPOE is unable to reach its full potential.

Accordingly, there exists a need to provide an improved framework to address these deficiencies.

### SUMMARY

The present disclosure relates to a framework for providing workflow guidance. In accordance with one aspect, a workflow graph is retrieved from a pre-built knowledge base. An end node of the workflow graph may represent a user's desired workflow point-state associated with a workflow system. The workflow graph may be used to determine the most efficient path from a current workflow point-state to the desired workflow point-state. A suggestion of the next task to be performed by the user may then be provided in accordance with the most efficient path.

In accordance with another aspect, a workflow graph is built. The workflow graph may include nodes representative of workflow point-states and links connecting the nodes and representative of user tasks performed via a workflow system. The workflow graph may be updated as one or more expert users use the workflow system. Based on the workflow graph, user guidance may be provided to perform a desired workflow via the workflow system.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings. Furthermore, it should be noted that the same numbers are used throughout the drawings to reference like elements and features.

FIG. 1 shows an exemplary computer system, in which the techniques and devices in accordance with the present disclosure may be embodied;

FIG. 2a shows an exemplary initial workflow graph;

FIG. 2b shows an exemplary workflow graph for placing a medication order for a patient;

FIG. 3 shows another exemplary workflow graph;

FIG. 4 shows an exemplary method of guiding a user at run-time; and

FIG. 5 shows an exemplary method for determining the most efficient path within the workflow graph.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It is to be understood that the system and methods described herein may be implemented in various forms of hardware, software, firmware, special purpose processors, or a combination thereof. Preferably, the present invention is implemented in software as an application (e.g., n-tier application) comprising program instructions that are tangibly embodied on one or more program storage devices (e.g., magnetic floppy disk, RAM, CD ROM, ROM, etc.), and executable by any device or machine comprising suitable architecture. If written in a programming language conforming to a recognized standard, sequences of instructions designed to implement the methods can be compiled for execution on a variety of hardware platforms and for interface to a variety of operating systems. In addition, embodiments of the present framework are not described with reference to any particular programming language. It will be appreciated that a variety of programming languages may be used to implement embodiments of the present invention.

It is to be further understood that since at least a portion of the constituent system modules and method steps depicted in the accompanying Figures may be implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

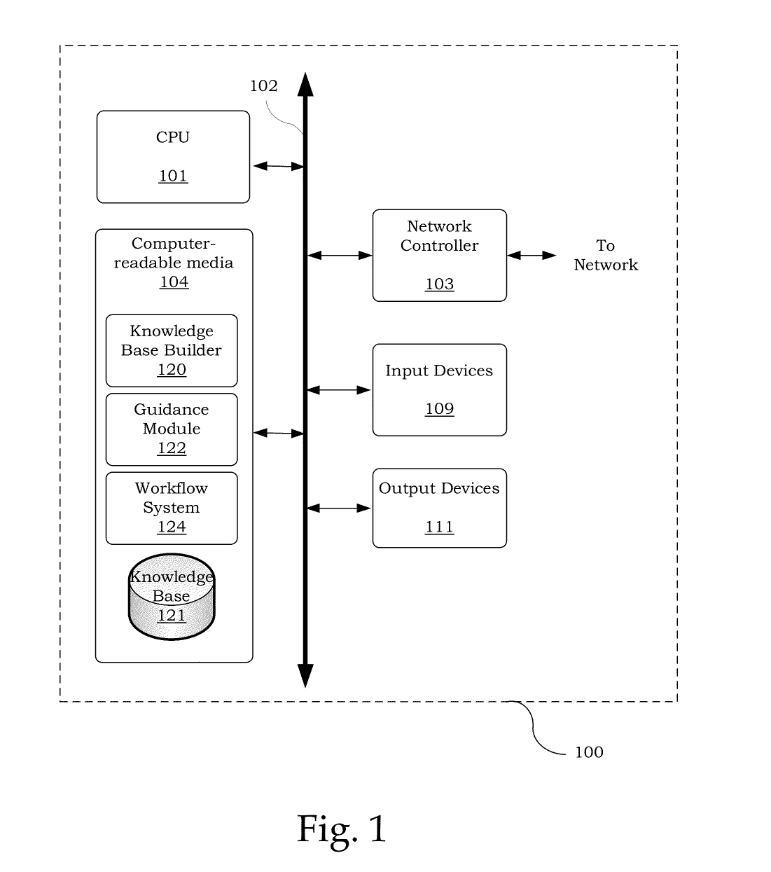

FIG. 1 shows an exemplary computer system for providing an interactive guide to system users through workflows. The computer system referred to generally as system 100 may include, inter alia, a processor such as a central processing unit (CPU) 101, a non-transitory computer-readable media 104, a network controller 103, an internal bus 102, one or more input devices 109 (e.g., keyboard, mouse, touch screen, gesture recognition module, microphone, etc.) and one and more output devices 111 (e.g., monitor, speaker, etc.). Computer system 100 may further include support circuits such as a cache, a power supply, clock circuits and a communications bus. Various other peripheral devices, such as additional data storage devices and printing devices may also be connected to the computer system 100.

The present technology may be implemented in various forms of hardware, software, firmware, special purpose processors, or a combination thereof, either as part of the microinstruction code or as part of an application program or software product, or a combination thereof, which is executed via the operating system. In one implementation, the techniques described herein may be implemented as computer-readable program code tangibly embodied in non-transitory computer-readable media 104. Non-transitory computer-readable media 104 may include one or more memory storage devices such as random access memory (RAM), read only memory (ROM), magnetic floppy disk, flash memory, and other types of memories, or a combination thereof.

The present techniques may be implemented by a knowledge base builder 120, a guidance module 122 and a workflow system 124 that are stored in computer-readable media 104. Guidance module 122 serves to provide run-time guidance for users of workflow system 124 to carry out the desired workflow. The guidance may be generated based on the prior-built knowledge base 121. Workflow system 124 may generate a user interface (e.g., graphical user interface) to enable a user to perform various tasks (or actions) associated with a workflow. The user interface may be presented (e.g., displayed) on the output device 111, for example. In some implementations, workflow system 124 is a computerized physician order entry (CPOE) system. A CPOE system allows a user to perform various tasks or actions (e.g., add, edit, select, sign, view, etc.) associated with order entry for healthcare services and/or goods, such as laboratory tests, medications, radiology procedures, diagnostic tests, therapeutic procedures, and so forth. Any other types of order entry or workflow systems may also be implemented.

Knowledge base builder 120 serves to build a knowledge base 121 that stores one or more workflow graphs representative of workflows that may be performed via workflow system 124. More particularly, knowledge base builder 120 may identify all workflows pertaining to workflow system 124, and build a workflow graph representative of each identified workflow. An initial knowledge base 121 may first be built. The knowledge base 121 may then be continuously updated as expert users use the workflow system 124. Expert users are those users who have extended experience and understanding of the workflow system 124 and associated workflows. They may be selected and assigned to use the system 124 so as to build the workflow graphs. Such expert users may be internal or external (e.g., customer) to the system developing organization. The expert users may also be role-based, such as Physicians, Nurses, Pharmacists, etc.

As such, the computer system 100 comprises a general purpose computer system that becomes a specific purpose computer system when executing the computer-readable program code. It is to be understood that, because some of the constituent system components and method steps depicted in the accompanying figures can be implemented in software, the actual connections between the systems components (or the process steps) may differ depending upon the manner in which the present framework is programmed. For example, the system 100 may be implemented in a client-server, peer-to-peer (P2P) or master/slave configuration. In such configurations, the system 100 may be communicatively coupled to other systems or components via a network, such as an Intranet, a local area network (LAN), a wide area network (WAN), P2P, a global computer network (e.g., Internet), a wireless communications network, or any combination thereof. Given the teachings of the present invention provided herein, one of ordinary skill in the related art will be able to contemplate these and similar implementations or configurations of the present invention.

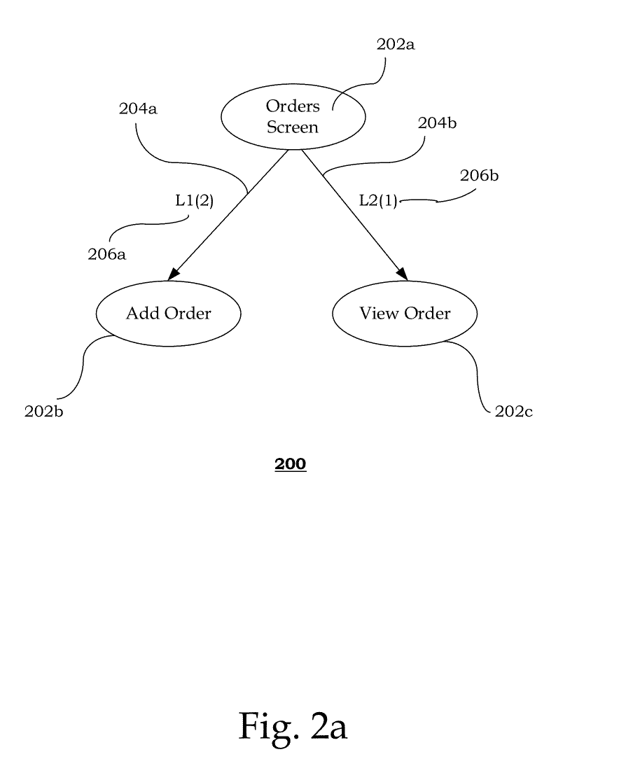

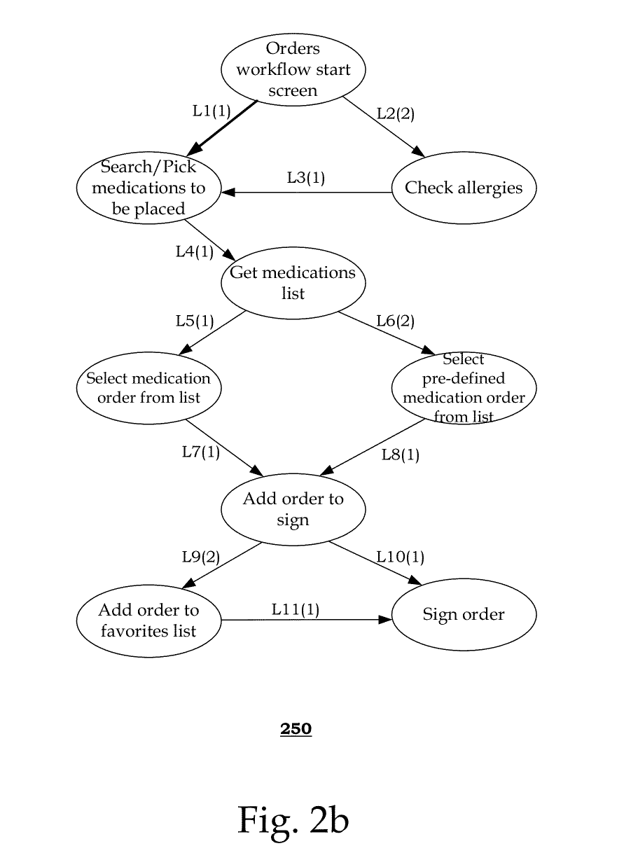

FIG. 2a shows an exemplary initial workflow graph 200. As shown, workflow graph 200 includes nodes 202a-c connected by links 204a-b. Each node represents a state of the workflow system 124 or a workflow point-state (i.e. WP-S), such as Orders Screen, Add Order, View Order, etc. Two nodes are connected by a link, which represents the user task required to be performed so as to transition from one node to another. The user task may be, for instance, an action performed via a user interface presented by workflow system 124. For example, from the “Orders Screen” node 202a, “Add Order” and “View Order” nodes 202b-c may be reached navigating link L1 and L2 respectively. Link L1 may be navigated by, for example, the user selecting an “Add Order” user interface element (e.g., button).

In some implementations, each link is associated with one or more pre-conditions that need to be satisfied before the link can be used to transition to the next node. For example, the pre-conditions that need to be satisfied before link L2 can be used may be: (a) There must be at least one order present to view; and (b) User should have necessary access levels to view orders.

One or more heuristics may also be associated with the link. Heuristics are application rules and/or conditions that increase the probability of using the particular link to transition to the next node. For example, a possible heuristic that can be associated with link L1 is: (a) Patient is newly registered.

In some implementations, each link is associated with an initial desirability factor 206a-b. A desirability factor represents the preference level of that link. For instance, if the desirability factor of link L1 is 2 (represented by L1(2)) and that of link L2 is 1 (represented by L2(1)), link L1 is preferred over L2 when navigating from the Orders Screen node 202a to the next node. The desirability factors 206a-b may be dynamically updated over time as the workflow system 124 is used.

FIG. 2b shows an exemplary workflow graph 250 for a physician ordering a medication order for a patient. With respect to link L1, for instance, associated pre-conditions may include: (1) User has proper rights to search and/or add orders for patient; (2) Patient and patient's visit are in proper state to receive orders. Heuristics assigned to link L1 may include: (1) Patient is newly registered, and therefore user is highly likely to add a new order; and (2) Patient is assessed with a new disease or ailment recently, and is highly likely to need a new order. It is understood that other pre-conditions and heuristics may also be associated with this and other links of the workflow graph.

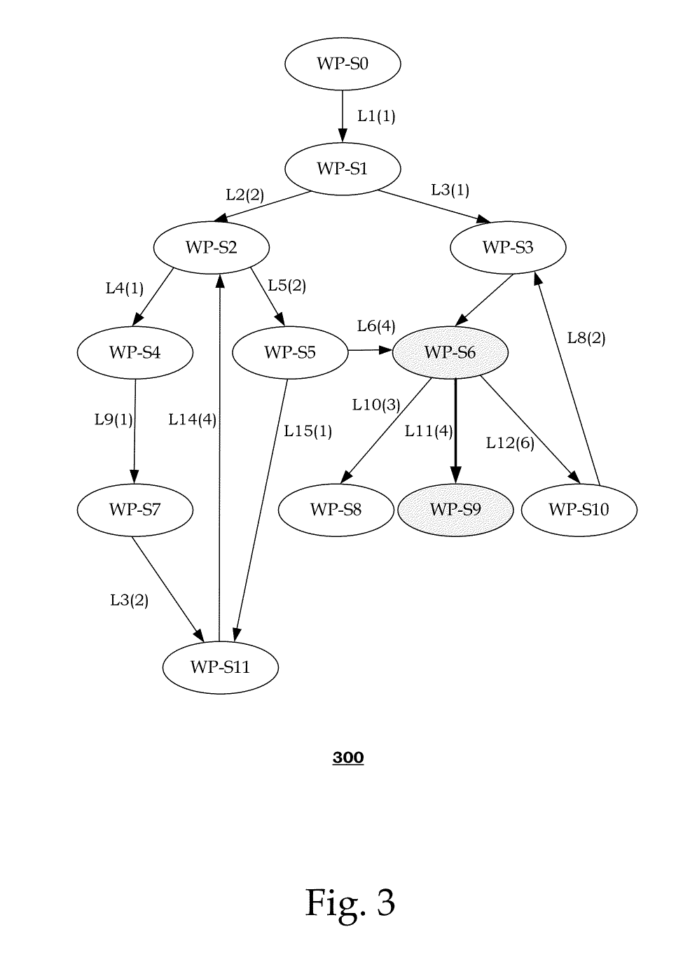

FIG. 3 shows another exemplary workflow graph 300 for an application. The workflow graph 300 may be dynamically updated as expert users use the workflow system 124. As discussed previously, expert users may be selected and assigned to use the workflow system 124 so as to build the workflow graphs and discover efficient paths within the workflow graphs. For example, desirability factors (e.g., L2(2), L3(1), etc.) associated with the respective links may be continuously updated over time.

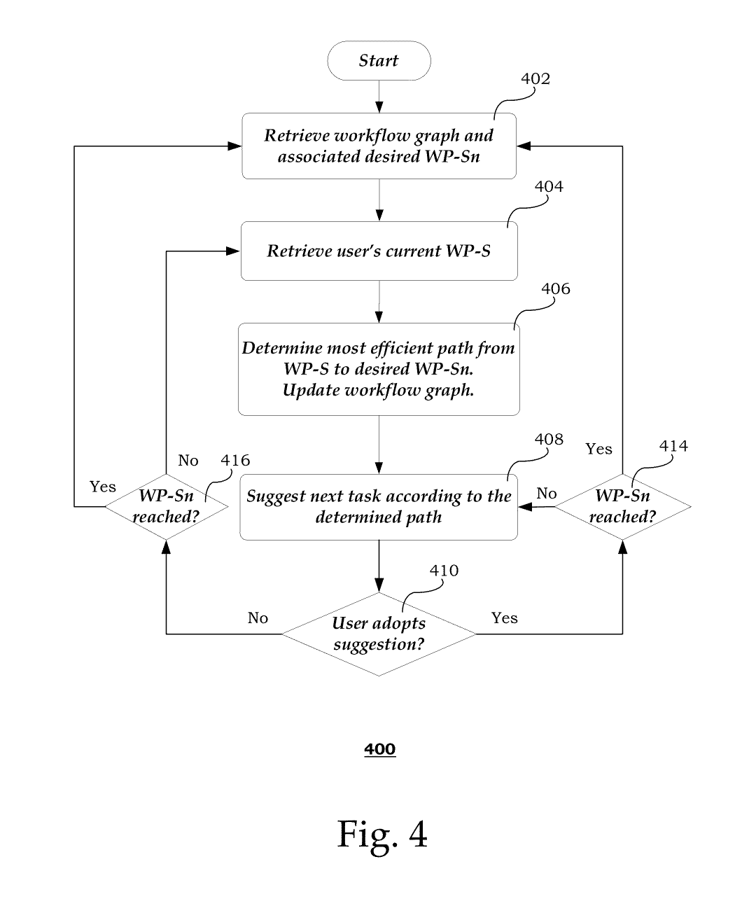

FIG. 4 shows an exemplary method 400 of guiding a user at run-time using a pre-built knowledge base to perform a desired workflow. The steps of the method 400 may be performed in the order shown or a different order. Additional, different, or fewer steps may be provided. Further, the method 400 may be implemented with the system 100 of FIG. 1, a different system, or a combination thereof.

At 402, guidance module 122 retrieves a workflow graph representative of a user's desired workflow. The user may input the desired workflow he or she wants to perform via a user interface (e.g., graphical user interface) presented by workflow system 124. For instance, a list of possible workflows may be presented to the user. The user may select a workflow to, for example, place a medication order for a patient. The workflow graph corresponding to such desired workflow may then be retrieved from the knowledge base 121 and the end node of the workflow graph represents the user's desired workflow point-state (WP-Sn).

At 404, guidance module 122 fetches the user's current workflow point-state (WP-S). The current workflow point-state (WP-S) is the state of the workflow system 124 caused by the user's most recent task (e.g., user interface action). For example, referring to FIG. 2a, if the user has most recently clicked the “Add Order” button presented by a user interface of the workflow system 124, the current state workflow point-state (WP-S) may be “Add Order”. Guidance module 122 may fetch the workflow point-state from workflow system 124.

Returning to FIG. 4, at 406, guidance module 122 determines the most efficient path within the workflow graph from current workflow point-state (WP-S) to desired workflow point-state (WP-Sn) to accomplish the desired workflow. This may be performed by using the pre-built knowledge base 121 including, but not limited to, heuristics, pre-conditions and desirability factors associated with the workflow graph. The workflow graph may also be updated during this step.

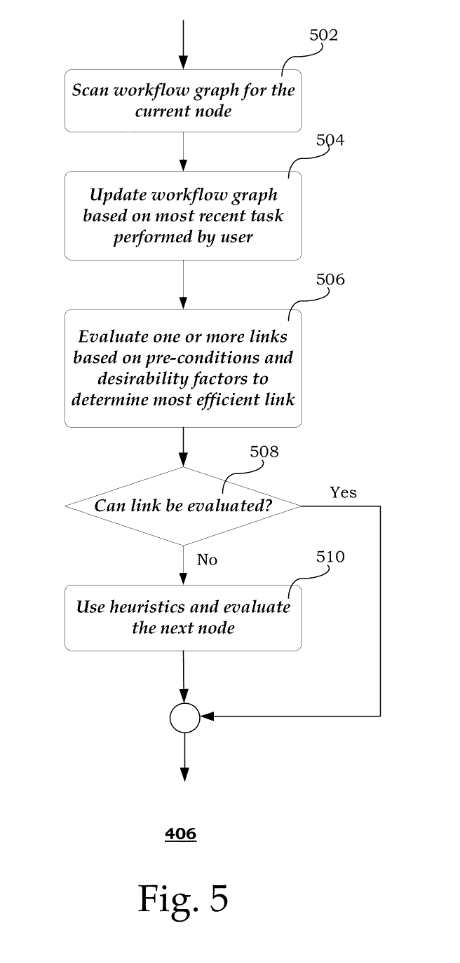

FIG. 5 shows an exemplary method for determining the most efficient path within the workflow graph. The steps of the method 406 may be performed in the order shown or a different order. Additional, different, or fewer steps may be provided. Further, the method 406 may be implemented with the system 100 of FIG. 1, a different system, or a combination thereof.

At 502, guidance module 122 scans the workflow graph for the current node corresponding to the current workflow point-state.

At 504, guidance module 122 updates the workflow graph based on the most recent task performed by the user. The desirability factor associated with the link (to the current node) representing the most recent task may be updated. For instance, referring to FIG. 2a, if the user clicked on “Add Order” button, the desirability factor of link 204a may be increased from 2 to 3 to indicate a higher preference level. Accordingly, as these users (e.g., expert users) use the workflow system 124, the initial workflow graph is updated to build the most efficient (or desired) paths for the workflow.

Returning to FIG. 5, at 506, guidance module 122 evaluates one or more links from the current node to determine the most efficient link that leads from the current node towards the desired workflow point-state WP-Sn. The most efficient link may be the most preferred link (e.g., highest desirability factor) with all associated pre-conditions satisfied. Referring to FIG. 3, for instance, the current node may be the node that represents workflow point-state WP-S6. There are three possible links leading away from the current node: L10, L11 and L12. Assuming that the pre-conditions of only links L10 and L11 are satisfied, link L11 may be evaluated as the most efficient link since it has the higher desirability factor.

Returning to FIG. 5, at 508, guidance module 122 determines if the links can be evaluated in the previous step 506. In some situations, it may not be possible to evaluate the links when, for example, the desirability factors are the same for two links. It may also be possible that none of the possible links have all pre-conditions satisfied.

If the links cannot be evaluated, at 510, guidance module 122 applies the heuristics associated with the links to determine the most efficient link. Since the heuristics provide an indication of the probability of taking a particular link, the link with the highest probability may be determined to be the most efficient link. The next node at which this link ends may then be evaluated to determine the next most efficient link.

Returning to FIG. 4, at 408, guidance module 122 suggests the next task according to the determined most efficient path. The next task is associated with the next link from the current node to reach the next workflow point-state (WP-S) along the most efficient path. For example, referring to FIG. 3, if link L11 is evaluated as the most efficient link from current node (WP-S6), the task associated with the link L11 may be provided as a suggestion. The suggestion may be provided via, for example, a user interface presented by workflow system 124.

At 410, guidance module 122 determines if the user has adopted the suggestion. If the user has adopted the suggestion, at 414, guidance module 122 determines if the desired workflow point-state (WP-Sn) has been achieved. If the desired workflow point-state (Wp-Sn) has been reached, the method 400 continues at 402 to process the next desired workflow point-state. If not, the method 400 continues at 408 to provide another suggestion of the next subsequent workflow point-state (WP-S) according to the determined path.

If the user did not adopt the suggestion, at 416, guidance module 122 determines if the desired workflow point-state (WP-Sn) has been reached. If the desired workflow point-state (Wp-Sn) has been reached, the method 400 continues at 402 to process the next desired workflow point-state. If not, the method 400 continues at 404 to retrieve the user's current workflow point-state (WP-S) to re-determine the most efficient path. Accordingly, the user is dynamically guided in executing the desired workflow with expert actions.

The present framework advantageously allows hospitals and other healthcare organizations to speed up or even reduce the number of training hours of users (e.g., physicians using CPOE systems), thereby saving valuable time for the users' actual roles in the organization. By making the workflow intuitive within the system, it may be easier to win the support of the users and change the organization's perspective towards CPOE systems. The knowledge base, including the workflow graphs, is updated over time and can serve as an invaluable training tool for the organization.

While the present invention has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

1. Non-transitory computer-readable media having computer-executable instructions stored thereon, that when executed, cause a processor to execute steps comprising:
building a workflow graph including nodes representative of workflow point-states and links connecting the nodes and are representative of user tasks performed via a workflow system;
updating the workflow graph as one or more expert users use the workflow system; and
providing user guidance, based on the workflow graph, to perform a desired workflow via the workflow system.

2. The computer-readable media of claim 1, wherein updating the workflow graph comprises updating one or more desirability factors associated with one or more links of the workflow graph.

3. The computer-readable media of claim 1, wherein the workflow system comprises a computerized physician order entry system.

4. A method of providing workflow guidance, comprising:
retrieving a workflow graph from a pre-built knowledge base, wherein an end node of the workflow graph is representative of a user's desired workflow point-state associated with a workflow system;
determining, based on the workflow graph, a most efficient path from a current workflow point-state to the desired workflow point-state to perform the desired workflow via the workflow system; and
providing, according to the determined most efficient path, a suggestion of a next task to be performed by the user.

5. The method of claim 4 further comprising:
building the knowledge base including the workflow graph; and
updating the knowledge base as one or more users use the workflow system.

6. The method of claim 5 wherein building the knowledge base comprises associating one or more heuristics with one or more links of the workflow graph.

7. The method of claim 5 wherein building the knowledge base comprises associating one or more pre-conditions with one or more links of the workflow graph.

8. The method of claim 5 wherein updating the knowledge base comprises updating one or more desirability factors associated with one or more links of the workflow graph.

9. The method of claim 4 wherein determining the most efficient path comprises:
scanning the workflow graph for a current node that represents the current workflow point-state;
evaluating one or more links leading from the current node to determine a most efficient link leading towards the desired workflow point-state.

10. The method of claim 9 wherein evaluating the one or more links comprises evaluating based on one or more pre-conditions and desirability factors associated with the one or more links.

11. The method of claim 4 wherein determining the most efficient path comprises using one or more heuristics associated with one or more links leading from the current node to determine a most efficient link leading towards the desired workflow point-state.

12. The method of claim 4 further comprising:
determining if the user has adopted the suggestion; and
if the user has adopted the suggestion and the user's desired workflow point-state has not been achieved, providing another suggestion of the next task according to the determined most efficient path.

13. The method of claim 4 further comprising:
determining if the user has adopted the suggestion; and
if the user has not adopted the suggestion and the user's desired workflow point-state has not been achieved, re-determining, based on the workflow graph, a most efficient path from another current workflow point-state to the desired workflow point-state

14. A system for providing workflow guidance, comprising:
non-transitory computer-readable media having computer-executable instructions and a pre-built knowledge base stored thereon; and
a processor in communication with the non-transitory computer-readable media, the processor being operative with the computer-executable instructions to:
retrieve a workflow graph from the knowledge base, wherein an end node of the workflow graph is representative of a user's desired workflow point-state associated with a workflow system;
determine, based on the workflow graph, a most efficient path from a current workflow point-state to the desired workflow point-state; and
provide, according to the determined most efficient path, a suggestion of a next task to be performed by the user.

15. The system of claim 14 wherein the workflow system comprises a computerized physician order entry system.

16. The system of claim 14 wherein the processor is further operative with the computer-executable instructions to:
build the workflow graph in the knowledge base; and
update the workflow graph as one or more expert users use the workflow system.

17. The system of claim 16 wherein one or more links of the workflow graph are associated with one or more heuristics.

18. The system of claim 16 wherein one or more links of the workflow graph are associated with one or more pre-conditions.

19. The system of claim 16 wherein the processor is further operative with the computer-executable instructions to update the workflow graph by updating one or more desirability factors associated with one or more links of the workflow graph.

20. The system of claim 16 wherein the processor is further operative with the computer-executable instructions to determine the most efficient path based pre-conditions, desirability factors, heuristics, or a combination thereof, associated with links of the workflow graph.
